(19) United States
(12) Patent Application Publication
(10) Pub. No.: US 2004/0167781 A1
(43) Pub. Date: Aug. 26, 2004

(54) Voice output unit and navigation system

(76) Inventor: Yoshikazu Hirayama, Machida (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/761,336

(22) Filed: Jan. 22, 2004

(30) Foreign Application Priority Data
Jan. 23, 2003 (JP) 2003-014720

(51) Int. Cl. G10L 13/08

(52) U.S. Cl. 704/260

(57) ABSTRACT

A navigation system comprises a voice signal synthesizing section 33 which generates a voice signal from a text-based document, a speaker 17 which outputs the voice signal generated in the voice signal synthesizing section 33 as a voice, a drive circuit 18 thereof, a grasping section 31 which grasps a length of the text-based document, and a synthesizing control section 32 which allows the voice signal synthesizing section 33 to generate a voice signal an intonation of which has been changed. According to the navigation system, it is possible to enhance a sense of realism in voice output regarding plural types of sentence.

### BACKGROUND OF THE INVENTION

The present invention relates to a voice output unit which converts a text-based document into voice and outputs the voice thus converted, and a navigation system.

As a conventional voice output unit, there is a technical art as described in the Japanese Patent Laid-Open Publication No. 2002-108378, for example.

This voice output unit aims at changing pitch or speed of the voice, when a text-based document is converted into voice, according to a hometown of a person who created the document, so that a sense of realism can be given to a listener.

### SUMMARY OF THE INVENTION

However, in the conventional art, when this voice output unit functions as a navigation system, for example, it is not possible to recognize a hometown and the like of a document creator of any type of the document, such as road guidance and an E-mail obtained via the Internet. Consequently, the voice is outputted with a same intonation, speed and so on. Under this situation, if the road guidance comes into while the listener is listening to the E-mail, there is a problem that he or she may miss the road guidance.

Focusing attention on the foregoing problem of the conventional art, the present invention is directed to providing a voice output unit and a navigation system which gives a sense of realism to a listener, even if there are plural types of documents other than narrative or the like in which a hometown or the like of a document creator can be recognized, and which also features that even when the document is switched to a different type of document, it can be easily perceived by the listener.

In order to achieve the above object, the voice output unit of the present invention comprises,

a voice signal synthesizer for generating a voice signal from said text-based document,

an output means which outputs as a voice said voice signal generated in said voice signal synthesizer,

a grasping means which grasps contents or a length of said text-based document, and

a synthesizing controller for allowing said voice signal synthesizer to generate said voice signal in which a tone quality including at least intonation is changed, according to the contents or the length of said text-based document grasped in said grasping means, when said voice signal synthesizer generates said voice signal from said text-based document.

In order to achieve the above object, the navigation system of the present invention comprises,

a voice signal synthesizer for generating a voice signal from said text-based document,

an output means which outputs as a voice said voice signal generated by said voice signal synthesizer,

a grasping means which grasps said situation, and

a synthesizing controller for allowing said voice signal synthesizer to generate said voice signal in which a tone quality including at least one of intonation, volume, speed and key is changed, according to said situation grasped in said grasping means, when said voice signal synthesizer generates said voice signal from said text-based document.

Here, the grasping means grasps a situation in which road guidance is to be outputted, and a situation in which operation guidance is to be outputted. More preferably, it grasps a situation in which VICS information is to be outputted, and a situation in which network information via the Internet is to be outputted.

According to the present invention as described above, even if there are plural types of documents other than narrative in which a hometown and the like of a document creator can be recognized, a voice intonation and the like are changed according to a length or contents of the text-based document, or a situation what type of voice output is to be made. Therefore, it is possible to give a sense of realism to a listener and even when the document is switched to a different type of document, it can be easily perceived by the listener.

### BRIEF DESCRIPTION OF THE DRAWINGS

FIG. 1 is a functional block diagram of a navigation system according to the first embodiment of the present invention.

FIG. 2 is flowchart showing an operation of a voice control section according to the first embodiment of the present invention.

FIG. 3 is flowchart showing an operation of the voice control section according to the second embodiment of the present invention.

FIG. 4 is an explanatory diagram showing parameter settings for various types of situations according to the second embodiment of the present invention.

### DESCRIPTION OF THE PREFERRED EMBODIMENTS

Preferred embodiments relating to the present invention will be explained with reference to the attached drawings.

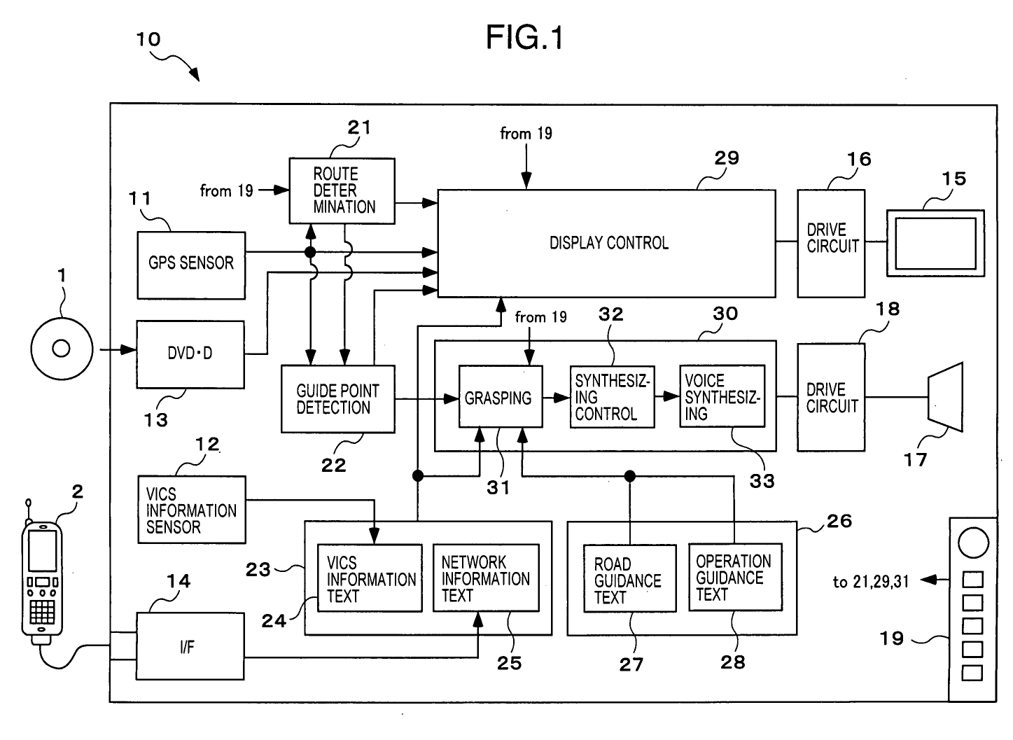

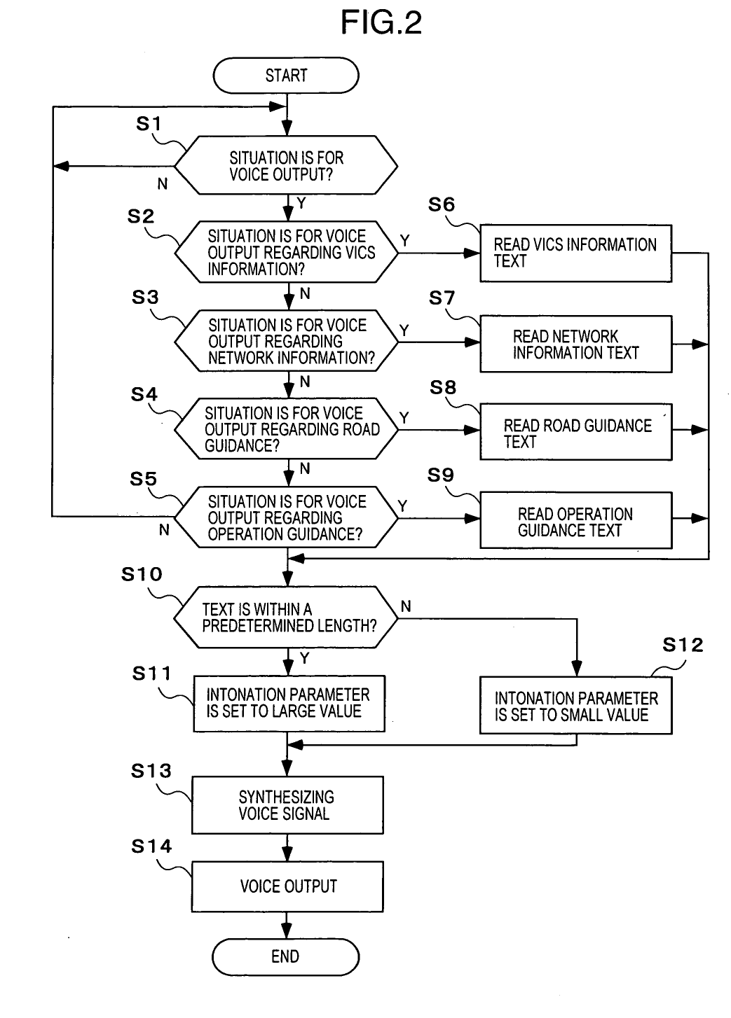

Referring to FIG. 1 and FIG. 2, a navigation system functioning as a voice output unit of the present invention will be explained.

As shown in FIG. 1, the navigation system 10 of the present embodiment comprises a GPS sensor 11 which receives a signal from a GPS (Global Positioning System) satellite, a VICS information sensor (VICS information receiving means) 12 which receives VICS (Vehicle Information and Communication System) information and a DVD unit 13 which reproduces DVD (Digital Versatile Disc) 1 with map information stored thereon, a communication interface (network information receiving means) 14 which transmits and receives data with a mobile phone 2, a display panel 15, a drive circuit 16 for driving the display panel 15, a speaker 17, a drive circuit 18 for driving the speaker 17, and an operation terminal 19 for various input operations.

Furthermore, this navigation system 10 comprises a route determining section 21 which determines a scheduled route and a guide point, based on a destination inputted by the operation on the operation terminal 19 and a current position obtained from the GPS sensor 11, a guide point detecting section 22 which determines whether or not the current position thus obtained from the GPS sensor 11 is a guide point, a first text storing section 23 which stores the VICS information obtained from the VICS information sensor 12, and network information such as news, E-mail and the like obtained from a mobile phone 2 via the Internet, a second text storing section 26 which stores a predetermined guidance such as road guidance and operation guidance of the system, a display control section 29 which controls a display output of the display panel 15, and a voice control section 30 which controls a voice output from the speaker 17.

The first text storing section 23 comprises a VICS information text storing section 24 which stores VICS information text, and a network information text storing section 25 which stores network information. The second text storing section 26 comprises a road guidance text storing section 27 which previously stores a road guidance text, and an operation guidance text storing section 28 which previously stores operation guidance text of the system.

The voice control section 30 comprises a grasping section 31, which grasps a situation to know what text is to be vocally outputted in response to a signal from the guide point detecting section 22 or the operation terminal 19, takes out a corresponding text from the storing sections 23 and 26, and recognizes the length of the text, a voice signal synthesizing section 33 which converts the text into a voice signal, and a synthesizing control section 32 which controls a generation of the voice signal from the voice signal synthesizing section 33.

In the present embodiment, the DVD unit 13 is employed for reproducing the map information. However, if the storage media on which the map information is stored is another type of media, such as CD (Compact Disc) and IC (Integrated Circuit) card, it is a matter of course to employ a reproducing unit conforming to the media, such as CD unit and IC card reader.

Next, operations of the navigation system will be explained.

The route determining section 21 determines a scheduled route, based on a destination inputted by operating the operation terminal 19 and a current position obtained by the GPS sensor 11, and also determines a guide point as a point as to which the road guidance is to be carried out, on the way of the scheduled route. The display control section 29 obtains the scheduled route from the route determining section 21 in response to the operation of the operation terminal 19, and displays the scheduled route on the display panel 15. The display control section 29 also displays on the display panel 15 a peripheral map of the current position and the scheduled route within the peripheral map, based on the map information from the DVD 1 reproduced by the DVD unit 13 and the current position obtained by the GPS sensor 11.

When the guide point detecting section 22 detects that any one of the plurality of guide points determined by the route determining section 21 becomes the current position indicated by the GPS sensor, a notification is made to the display control section 29 and the voice control section 30. When the display control section 29 receives the notification above, it displays on the display panel 15 a predetermined image to be displayed on the pertinent guide point. For example, when the guide point is positioned at 400 m before a cross point where a right-turn is to be made, am image displayed on the display panel 15 is a detailed map around the cross point, a scheduled route within the detailed map, and so on. When the voice control section 30 receives the above notification, it reads out a road guidance text corresponding to the notification, from the texts stored in the rode guidance text storing section 27, converts the road guidance text into a voice signal, and outputs the voice signal from the speaker 17.

When the VICS information sensor 12 receives VICS information, the display control section 29 and the voice control section 30 are notified of the VICS information, and it is stored in the VICS information text storing section 24 of the first text storing section 23. When the display control section 29 receives the above notification, it reads out the VICS information text stored in the VICS information text storing section 24, and displays the text on the display panel 15. When the voice control section 30 receives the above notification, it reads out the VICS information text stored in the VICS information text storing section 24, and converts the VICS information text into a voice signal and outputs the signal from the speaker 17.

When the communication interface 14 receives network information such as E-mail and news from the mobile phone 2, the network information is stored in the network information text storing section 25. When the voice control section 30 receives a voice output notification as to the network information or the operation guidance by operating the operation terminal 19, it reads out a network information text or an operation guidance text in response to the notification, out of the texts stored in the network information text storing section 25 or the texts stored in the operation guidance text storing section 28, converts the network information text or the operation guidance text into a voice signal and outputs the voice signal from the speaker 17.

Next, detailed operations of the voice control section 30 will be explained with reference to the flowchart as shown in FIG. 2.

At first, it is determined whether or not the grasping section 31 of the voice control section 30 is in a state of voice outputting (step 1). This determination is made based on whether or not there is any input of a signal from the guide point detecting section 22 or the VICS information sensor 12, or there is any input of a signal instructing a voice output by operating the operation terminal 19. When the grasping section 31 receives a signal from the guide point detecting section 22 or the like, and determines as being in a state of voice outputting, it grasps the current situation to know what kind of voice output is to be made based on the signal (steps 2 to 5). Specifically, it grasps the current situation to know, whether the voice output is to be made regarding VICS information (step 9), network information (step 3), a road guidance (step 4), or an operation guidance (step 5).

Subsequently, the grasping section 31 reads out a text according to the situation grasped in steps 2 to 5 from the storing sections 23 and 24 (steps 6 to 9), and grasps the length of the text to determine whether or not it is within a predetermined length. Then, the text and the result of the determination are passed to the synthesizing control section 32 (step 10). Here, as the predetermined length of the text, it is set to approximately 100 bytes. As the predetermined length of the text is set to 100 bytes, most of the road guidance texts and operation guidance texts are treated as short. On the other hand, most of the VICS information texts and the network information texts are treated as long.

When the length of the text thus passed is within a predetermined length, that is, it is a short text, the synthesizing control section 32 sets an intonation parameter defining a voice intonation, to a predefined large value, and passes both the intonation parameter and the text to the voice signal synthesizing section 33 (step 11). On the other hand, when the text thus passed is long, the synthesizing control section 32 sets the intonation parameter to a predefined small value, and passes both the intonation parameter and the text to the voice signal synthesizing section 33 (step 12).

The voice signal synthesizing section 33 converts the text passed from the synthesizing control section 32 into a voice signal. At this stage, the voice signal is generated by use of the intonation parameter passed from the synthesizing control section 32 (step 13). Here, when a small value is set as the intonation parameter, the voice is made less inflective, and when a large value is set as the intonation parameter, the voice is made more inflective. Therefore, the road guidance or operation guidance constructed by a short sentence becomes more inflective, and the VICS information or network information constructed by relatively long sentence becomes less inflective. The voice signal synthesizing section 33 outputs thus generated voice signal to the driving circuit 18, and then outputs the voice from the speaker 17 (step 14).

As described above, since the voice intonation is varied according to the length of the text, it is possible to give the listener a sense of realism, even if there are plural types of documents other than narrative or the like in which a hometown or the like of a document creator can be recognized. Further, in the present embodiment, since the voice of the road guidance or operation guidance is made more inflective, a driver can be reminded that important information is now being outputted.

In the embodiment above, only the voice intonation is changed according to the text length, but also a voice speed, volume or key other than the intonation may be varied simultaneously. Here, a length of the text is grasped, but it may also be possible to grasp contents of the text and to vary the voice intonation and the like according to the contents. As to the text contents, upon reading out a text from each of the storing sections 23 and 26, it is possible to grasp whether the text is a road guidance, network information or the like, by referring to a header part of the text.

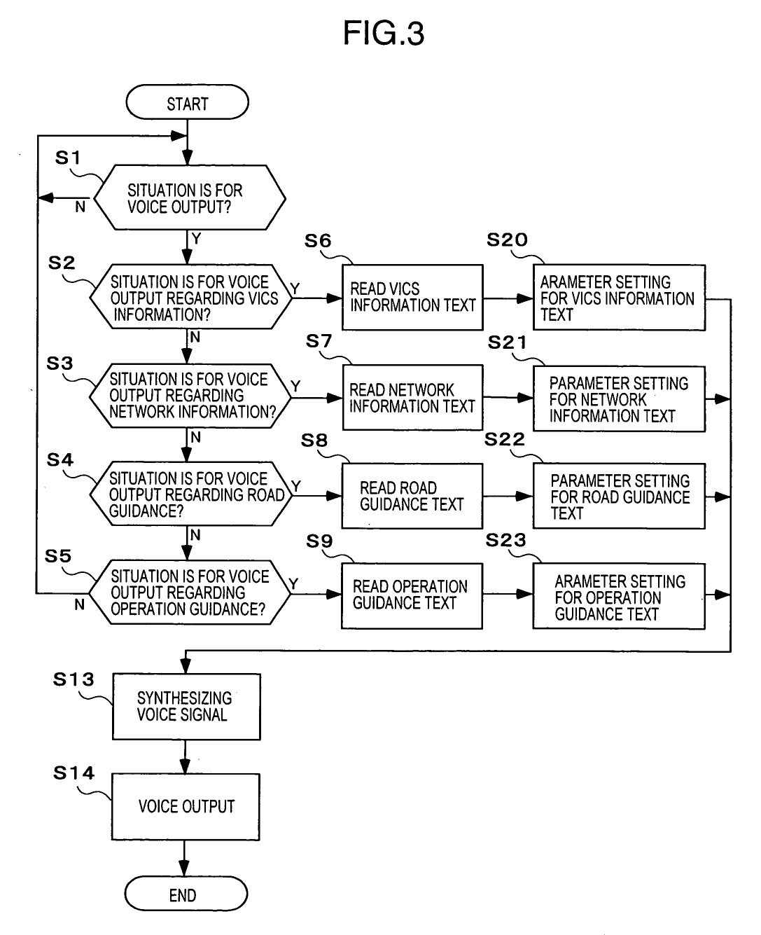

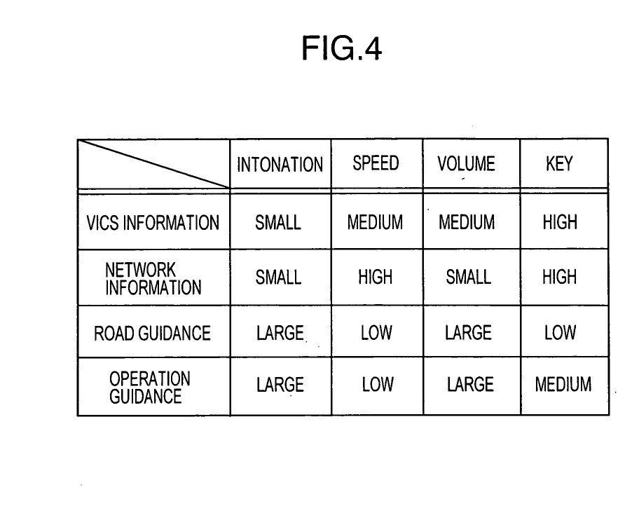

Next, with reference to FIG. 3 and FIG. 4, a navigation system according to the second embodiment of the present invention will be explained.

The configuration of the navigation system of the present embodiment is basically same as that of the first embodiment as described above with FIG. 1. The Navigation system of the present embodiment, however, is different from the first embodiment in operations of the grasping section 31 and the synthesizing control section 32 of the voice control section 30.

In the following, only the operation of the voice control section 30 of the present embodiment will be explained with reference to FIG. 3.

At first, similar to the first embodiment, the grasping section 31 of the voice control section 30 determines whether or not it is a situation to output a voice, according to the existence of a signal from the guide point detecting section 22 or the like (step 1). Then, the grasping section 31 grasps the current situation to know what kind of voice output is to be made, based on the signal from the guide point detecting section 22 or the like (Steps 2 to 5). In other words, as described above, the current situation is grasped to know, whether the voice output is to be made regarding VICS information (step 2), network information (step 3), a road guidance (step 4), or an operation guidance (step 5).

Subsequently, the grasping section 31 reads out a text according to the situation thus grasped in steps 2 to 5 (steps 6 to 9), and passes to the synthesizing control section 32 both the text and the situation previously grasped.

The synthesizing control section 32 sets a voice intonation parameter, a voice speed parameter, a voice volume parameter, and a voice key parameter, and passes both these parameters and the text to the voice signal synthesizing section 33 (Steps 20 to 23). Specifically, each parameter has settings as shown in FIG. 4. As for the VICS information, each parameter is defined such that the intonation is small, the speed and the volume are medium, and the key is high (Step 20). As for the network information, each parameter is defined such that the intonation is small, the speed is high, the volume is small, and the key is high (Step 21). As for the road guidance, each parameter is defined such that the intonation is large, the speed is low, the volume is large and the key is low (step 22). As for the operation guidance, each parameter is defined such that the intonation is large, the speed is low, the volume is large and the key is medium (step 23). The settings for each parameter are not limited to those as described above. Further, the settings for each parameter may be defined freely with the operation of the operation terminal 19 by the driver himself or herself, since there are preferences for the settings depending on the driver, i.e., the listener, such as male or female, or a younger person or an elder person.

The voice signal synthesizing section 33 converts the text passed from the synthesizing control section 32. At this timing, the voice signal is generated by use of each parameter passed from the synthesizing control section 32 (step 13). Then, the generated voice signal is outputted to the driving circuit 18, and voice is outputted from the speaker 17 (step 14).

As described above, according to the present embodiment, it is possible to vary the intonation, speed and the like, according to the situation what kind of voice is to be outputted.

What is claimed is:

1. A voice output unit which converts a text-based document into a voice and outputs the voice, comprising,
a voice signal synthesizer for generating a voice signal from said text-based document,
an output means which outputs as a voice said voice signal generated in said voice signal synthesizer,
a grasping means which grasps contents or a length of said text-based document, and
a synthesizing controller for allowing said voice signal synthesizer to generate said voice signal in which a tone quality including at least intonation is changed, according to the contents or the length of said text-based document grasped in said grasping means, when said voice signal synthesizer generates said voice signal from said text-based document.

2. A navigation system which converts a corresponding text-based document into a voice according to a situation what kind of voice is to be outputted, and outputs the voice, comprising,
a voice signal synthesizer for generating a voice signal from said text-based document,
an output means which outputs as a voice said voice signal generated by said voice signal synthesizer,
a grasping means which grasps said situation, and
a synthesizing controller for allowing said voice signal synthesizer to generate said voice signal in which a tone quality including at least one of intonation, volume, speed and key is changed, according to said situation grasped in said grasping means, when said voice signal synthesizer generates said voice signal from said text-based document.

3. A navigation system according to claim 2, wherein,
said grasping means grasps at least a situation in which road guidance is to be outputted, and a situation in which an operation guidance of the system is to be outputted.

4. A navigation system according to claim 3, further comprising a VICS (Vehicle Information and Communication System) information receiver for receiving VICS information, wherein,
said grasping means further grasps a situation in which said VICS information is to be outputted.

5. A navigation system according to claim 3, further comprising a network information receiver for receiving network information via the Internet, wherein,
said grasping means further grasps a situation in which said network information is to be outputted.

6. A navigation system according to claim 4, further comprising a network information receiver for receiving network information via the Internet, wherein,
said grasping means further grasps a situation in which said network information is to be outputted.
